(19) United States
(12) Patent Application Publication
(10) Pub. No.: US 2025/0101191 A1
(43) Pub. Date: Mar. 27, 2025

(54) GLASS FIBER-REINFORCED RESIN MOLDED PRODUCT

(71) Applicant: NITTO BOSEKI CO., LTD., FUKUSHIMA-SHI, FUKUSHIMA (JP)

(72) Inventor: Ryo SASAKI, FUKUSHIMA-SHI, FUKUSHIMA (JP)

(21) Appl. No.: 18/730,844

(22) PCT Filed: Feb. 2, 2023
(86) PCT No.: PCT/JP2023/003464

§ 371 Date: Jul. 22, 2024

(30) Foreign Application Priority Data
Apr. 15, 2022 (JP) 2022-067868

(51) Int. Cl. C08J 5/04; C08G 65/40; C08K 7/14

(52) U.S. Cl. CPC C08J 5/043; C08G 65/4012; C08K 7/14; C08G 2650/40; C08K 2201/003

(57) ABSTRACT

A glass-fiber-reinforced resin molded product that has impact absorption properties at break and impact resistance at the unbroken phase in combination and in good balance with handleability. The glass-fiber-reinforced resin molded product contains glass fiber having a fiber diameter D within 5.0 to 17.0 μm, a linear expansion coefficient α within 2.0 to 6.0 ppm/K, and a tensile modulus E within 58 to 92 GPa, and has a glass fiber content C within 10.0 to 50.0% by mass with respect to the total amount of the glass-fiber-reinforced resin molded product, and the heat of crystallization Q of the product is within 30.0 to 60.0 J/g with respect to the mass of resin contained in the glass-fiber-reinforced resin molded product, and D, α, E, C, and Q satisfy following formula (1):

$$16.02 \leq Q \times E / ( {D}^{1 / 3} \times {C}^{1 / 2} \times {α}^{2} ) \leq 27 \text{.70} \qquad ( 1 )$$

### TECHNICAL FIELD

The present invention relates to a glass-fiber-reinforced resin shaped article (molded product).

### BACKGROUND ART

Glass-fiber-reinforced resin molded products containing glass fiber as a reinforcing material have been known. For the glass fiber in the glass-fiber-reinforced resin molded products, glass fiber having an E glass composition (E glass fiber) is the most universally used.

Recent extension of applications of the glass-fiber-reinforced resin molded products, for example, to materials substituting metals for parts of portable electronic devices, automobiles, and the like has generated demand for high-level performance in the glass-fiber-reinforced resin molded products. In particular, the use of resins has been widely spread in applications in which satisfactory impact properties are needed such as automotive members, aerospace members, and housings of electronic devices such as smartphones, and resins having good impact properties such as polyaryl ether ketone have been used.

The glass fiber is also required to impart higher impact strength to glass-fiber-reinforced resin molded products, and the present applicant has proposed glass fiber that can impart higher impact strength than the E glass fiber to glass-fiber-reinforced resin molded products (see Patent Literature 1).

### CITATION LIST

### Patent Literature

Patent Literature 1: Japanese Patent Laid-Open No. 2017-31414

### SUMMARY OF INVENTION

### Technical Problem

The impact properties of the glass-fiber-reinforced resin molded products are evaluated from amounts of impact energy absorbed at break (hereinafter, may be referred to as impact absorption properties at break). However, it is rather desired for the glass-fiber-reinforced resin molded products to keep their shape, without being completely broken, when impact is applied. Accordingly, it is important for the glass-fiber-reinforced resin molded products not to have impact absorption properties at break solely but to have both impact absorption properties at break and impact resistance at the unbroken phase.

Nevertheless, glass-fiber-reinforced resin molded products with the glass fiber disclosed in Patent Literature 1 have high impact absorption properties at break, but have a disadvantage of insufficient impact resistance at the unbroken phase. Glass-fiber-reinforced resin molded products having high impact absorption properties exhibit large amounts of deformation (amounts of strain) at impact, but have low rigidity, thus having a disadvantage of poor handleability.

An object of the present invention is to solve those disadvantages and provide a glass-fiber-reinforced resin molded product that has impact absorption properties at break and impact resistance at the unbroken phase in combination and in good balance with handleability.

### Solution to Problem

To achieve the object, the glass-fiber-reinforced resin molded product of the present invention is characterized in that glass fiber contained in the glass-fiber-reinforced resin molded product has a fiber diameter D in the range of 5.0 to 17.0 μm, the glass fiber has a linear expansion coefficient α in the range of 2.0 to 6.0 ppm/K, the glass fiber has a tensile modulus E in the range of 58 to 92 GPa, the glass-fiber-reinforced resin molded product has a glass fiber content C in the range of 10.0 to 50.0% by mass with respect to the total amount of the glass-fiber-reinforced resin molded product, the heat of crystallization Q of the glass-fiber-reinforced resin molded product is in the range of 30.0 to 60.0 J/g with respect to the mass of resin contained in the glass-fiber-reinforced resin molded product, and the D, α, E, C, and Q satisfy the following formula (1):

$$16.02 \leq Q \times E / ( {D}^{1 / 3} \times {C}^{1 / 2} \times {α}^{2} ) \leq 27 \text{.70} \qquad ( 1 )$$

The glass-fiber-reinforced resin molded product of the present invention, when the D, α, E, C, and Q satisfy the formula of (1), has impact absorption properties at break and impact resistance at the unbroken phase in combination and in good balance with handleability.

In the glass-fiber-reinforced resin molded product of the present invention, the D, α, E, C, Q preferably satisfy the following formula (2), and more preferably satisfy the following formula (3):

$$18.74 \leq Q \times E / ( {D}^{1 / 3} \times {C}^{1 / 2} \times {α}^{2} ) \leq 21 \text{.74} \qquad ( 2 )$$

$$20.24 \leq Q \times E / ( {D}^{1 / 3} \times {C}^{1 / 2} \times {α}^{2} ) \leq 21 \text{.54} \qquad ( 3 )$$

The glass-fiber-reinforced resin molded product of the present invention, when the D, α, E, C, and Q satisfy the formula (2), has impact absorption properties at break and impact resistance at the unbroken phase in combination and in better balance with handleability. The glass-fiber-reinforced resin molded product of the present invention, when the formula (3) is satisfied, has impact absorption properties at break and impact resistance at the unbroken phase in combination and in much better balance with handleability.

In the glass-fiber-reinforced resin molded product of the present invention, the resin is preferably polyaryl ether ketone.

### DESCRIPTION OF EMBODIMENTS

Hereinafter, embodiments of the present invention will be described in detail.

The glass-fiber-reinforced resin molded product of the present embodiment is such that glass fiber contained in the glass-fiber-reinforced resin molded product has a fiber diameter D in the range of 5.0 to 17.0 μm, the glass fiber has a linear expansion coefficient cx in the range of 2.0 to 6.0 ppm/K, the glass fiber has a tensile modulus E in the range of 58 to 92 GPa, the glass-fiber-reinforced resin molded product has a glass fiber content C in the range of 10.0 to 50.0% by mass with respect to the total amount of the glass-fiber-reinforced resin molded product, the heat of crystallization Q of the glass-fiber-reinforced resin molded product is in the range of 30.0 to 60.0 J/g with respect to the mass of resin contained in the glass-fiber-reinforced resin molded product, and the D, α, E, C, and Q satisfy the following formula (1):

$$16.02 \leq Q \times E / ( {D}^{1 / 3} \times {C}^{1 / 2} \times {α}^{2} ) \leq 27 \text{.70} \qquad ( 1 )$$

The glass-fiber-reinforced resin molded product of the present embodiment can be obtained by, for example, kneading glass fiber and thermoplastic resin in a twin-screw kneader and injection-molding the obtained molding raw material. Alternatively, the glass-fiber-reinforced resin molded product of the present embodiment can be obtained with any of other known molding methods including injection compression molding methods, two-color molding methods, hollow molding methods, foam molding methods (including those with supercritical fluid), insert molding methods, in-mold coating molding methods, extrusion molding methods, sheet molding methods, thermoforming methods, rotational molding methods, laminate molding methods, press molding methods, blow molding methods, stamping molding methods, infusion methods, hand lay-up methods, spray-up methods, resin transfer molding methods, sheet molding compound methods, bulk molding compound methods, pultrusion methods, and filament winding methods. Among these methods, injection molding methods are preferred because of good manufacture efficiency.

In manufacturing the glass-fiber-reinforced resin molded product of the present invention with an injection molding method, for example, chopped strands are kneaded with resin, and the resultant is then pushed out from a nozzle, processed into the shape of pellets by cutting to give a specific length in the range of 1 to 50 mm, and the pellets can be used as the molding raw material. The chopped strands are a product obtained by cutting glass fiber formed of a plurality of glass filaments bundled together into pieces having a length in the range of 1 to 25 mm. Chopped strands are typically distributed in a state in which a plurality of glass fiber cut pieces obtained by cutting as described above is contained in a bag-like package.

Alternatively, a roving is impregnated with melted thermoplastic resin, cooled, and then processed into the form of pellets by cutting to give a specific length, for example, in the range of 1 to 50 mm, and the pellets can be used as the molding raw material. The roving is glass fiber that is formed of a plurality of glass filaments bundled together and continuously wound. Rovings are typically distributed in a state in which a roving having a length of 1000 m or more is wound around a core material.

The thermoplastic resin in the glass-fiber-reinforced resin molded product of the present embodiment is preferably polyaryl ether ketone. Examples of the polyaryl ether ketone can include polyether ketone (PEK), polyether ether ketone (PEEK), polyether ketone ketone (PEKK), and polyether ether ketone ketone (PEEKK), and polyether ether ketone (PEEK) is particularly preferred.

In the glass-fiber-reinforced resin molded product of the present embodiment, the glass fiber has a specific linear expansion coefficient and a specific tensile modulus. The glass fiber is manufactured as follows.

First, a glass raw material (glass batch) is supplied to a melting furnace, and is melted, for example, at a temperature in the range of 1450 to 1600° C., giving a glass batch (molten glass). The glass batch is prepared in advance to have a glass composition for glass fiber on the basis of components contained in ores as glass raw materials, the content of each component, and the amount of each component volatilized in the melting process.

Next, the melted glass batch is drawn from 1 to 20000 nozzle tips of a bushing controlled at a predetermined temperature and rapidly cooled to form glass filaments.

Glass single fiber (glass filament) discharged from one nozzle tip or hole, and cooled and solidified typically has a perfect circle cross-sectional shape. On the other hand, when the above nozzle tip has a non-circular shape and has a protrusion or a notch for rapidly cooling the molten glass, controlling the temperature condition can provide a glass filament having a non-circular (e.g., ellipse, long oval) cross-sectional shape. Here, the cross-sectional shape is the shape of a transverse cross-section formed by cutting the glass filament along the plane perpendicular to the length direction.

Subsequently, a sizing agent or binder is applied to the formed glass filament with an applicator as a coating machine. Then, 1 to 20000 glass filaments are bundled together with a sizing shoe and simultaneously wound around a tube by a winder at high speed, giving the glass fiber.

In the glass-fiber-reinforced resin molded product of the present embodiment, the composition of the glass composition for glass fiber to form the glass fiber is not limited. Examples of glass compositions that the glass fiber may have include an E glass composition and an NE glass composition, and the glass composition is preferably an NE glass composition.

The NE glass composition specifically contains SiO₂ in the range of 48.0 to 62.0% by mass, B₂O₃ in the range of 17.0 to 26.0% by mass, and Al₂O₃ in the range of 9.0 to 18.0% by mass with respect to the total amount of the glass fiber, and may contain an additional component as the balance. Examples of the additional component can include, but are not limited to, MgO, CaO, SrO, Li₂O, Na₂O, K₂O, ZnO, F₂, Cl₂, and Fe₂O₃.

When the total content of SiO₂ and Al₂O₃ with respect to the total amount of the glass fiber is higher in the glass composition of the glass fiber, the glass fiber has a smaller linear expansion coefficient. On the other hand, when the total content of SiO₂ and Al₂O₃ with respect to the total amount of the glass fiber is lower in the glass composition of the glass fiber, the glass fiber tends to have a larger linear expansion coefficient.

When the content of B₂O₃ with respect to the total amount of the glass fiber is higher in the glass composition of the glass fiber, the glass fiber has a smaller tensile modulus. On the other hand, when the content of B₂O₃ with respect to the total amount of the glass fiber is lower in the glass composition of the glass fiber, the glass fiber tends to have a larger tensile modulus.

Regarding measurement of the content of each component in the glass composition, the content of Li as a light element can be measured with an ICP emission spectroscopic analyzer. The contents of the other elements can be measured with a wavelength dispersive X-ray fluorescence analyzer.

The following method can be exemplified as a measurement method. First, the glass batch is placed in a platinum crucible and melted with stirring while being held at a temperature of 1550° C. for 4 hours in an electric furnace to obtain homogeneous molten glass. Alternatively, the glass fiber is placed in a platinum crucible and melted with stirring while being held at a temperature of 1600° C. for 4 hours in an electric furnace to obtain homogeneous molten glass.

The glass batch is a product prepared by mixing a glass raw material. In the case where an organic matter is attaching to the surface of the glass fiber, or in the case where an organic matter (resin) is contained primarily as a reinforcing material in the glass fiber, the organic matter is removed before use, for example, by heating in a muffle furnace at 300 to 650° C. for about 0.5 to 24 hours.

Next, the obtained molten glass is poured onto a carbon plate to produce a glass cullet, and then the glass cullet is pulverized and powdered into glass powder.

Then, regarding Li as a light element, the glass powder is thermally decomposed with an acid and then quantitatively analyzed using an ICP emission spectroscopic analyzer. Regarding the other elements, the glass powder is molded into a disc shape by a pressing machine and then quantitatively analyzed using a wavelength dispersive X-ray fluorescence analyzer. Specifically, the quantitative analysis using a wavelength dispersive X-ray fluorescence analyzer can be performed with a calibration curve method using samples for a calibration curve prepared from results of measurement with a fundamental parameter method.

The content of each component in samples for a calibration curve can be quantitatively analyzed using an ICP emission spectroscopic analyzer. These quantitative analysis results are converted in terms of oxides to calculate the content of each component and the total amount, and the above content (% by mass) of each component can be determined from these numerical values.

The glass fiber contained in the glass-fiber-reinforced resin molded product of the present embodiment may be coated with an organic matter on the surface thereof for the purposes such as improvement of adhesiveness between glass fiber and a resin and improvement of uniform dispersibility of glass fiber in a mixture of glass fiber and a resin. Examples of such an organic matter include a resin or a silane coupling agent. The organic matter may be a composition including a lubricant, a surfactant, and the like, in addition to such a resin or silane coupling agent.

The organic matter covers the glass fiber at a rate in the range of 0.1 to 2.0% by mass based on the mass of the glass fiber in a state where it is not coated with the organic matter.

The glass fiber can be coated with an organic matter by applying the sizing agent or binder including a solution of the resin, the silane coupling agent, or a composition to the glass fiber using a known method such as a roller applicator, for example, in the manufacturing process of the glass fiber and then drying the glass fiber to which the solution of the resin, the silane coupling agent, or the composition is applied.

Examples of the resin can include urethane resins, epoxy resins, vinyl acetate resins, acrylic resins, modified polypropylene, particularly carboxylic acid-modified polypropylene, and a copolymer of (poly) carboxylic acid, particularly maleic acid, and an unsaturated monomer.

Examples of the silane coupling agent can include aminosilanes, chlorosilanes, epoxysilanes, mercaptosilanes, vinylsilanes, acrylsilanes, and cationic silanes. As the silane coupling agent, these compounds can be used singly or in combination of two or more.

Examples of the aminosilane include γ-aminopropyltriethoxysilane, N-β-(aminoethyl)-γ-aminopropyltrimethoxysilane, N-β-(aminoethyl)-N′-β-(aminoethyl)-γ-aminopropyltrimethoxysilane, and γ-anilinopropyltrimethoxysilane.

Examples of the chlorosilane include γ-chloropropyltrimethoxysilane.

Examples of the epoxysilane include γ-glycidoxypropyltrimethoxysilane and β-(3,4-epoxy cyclohexyl)ethyltrimethoxysilane.

Examples of the mercaptosilane can include γ-mercaptotrimethoxysilane.

Examples of the vinylsilane include vinyl trimethoxysilane and N-β-(N-vinylbenzylaminoethyl)-γ-aminopropyltrimethoxysilane.

Examples of the acrylsilane include γ-methacryloxypropyltrimethoxysilane.

Examples of the cationic silane include N-(vinylbenzyl)-2-aminoethyl-3-aminopropyltrimethoxysilane hydrochloride and N-phenyl-3-aminopropyltrimethoxysilane hydrochloride.

Examples of the lubricant include modified silicone oils, animal oils and hydrogenated products thereof, vegetable oils and hydrogenated products thereof, animal waxes, vegetable waxes, mineral waxes, condensates of a higher saturated fatty acid and a higher saturated alcohol, polyethyleneimine, polyalkylpolyamine alkylamide derivatives, fatty acid amides, and quaternary ammonium salts. As the lubricant, these can be used singly or in combinations of two or more.

Examples of the animal oil include beef tallow.

Examples of the vegetable oil include soybean oil, coconut oil, rapeseed oil, palm oil, and castor oil.

Examples of the animal wax include beeswax and lanolin.

Examples of the vegetable wax include candelilla wax and carnauba wax.

Examples of the mineral wax include paraffin wax and montan wax.

Examples of the condensate of a higher saturated fatty acid and a higher saturated alcohol include stearates such as lauryl stearate.

Examples of the fatty acid amide include dehydrated condensates of a polyethylenepolyamine such as diethylenetriamine, triethylenetetramine, or tetraethylenepentamine and a fatty acid such as lauric acid, myristic acid, palmitic acid, or stearic acid.

Examples of the quaternary ammonium salt include alkyltrimethylammonium salts such as lauryltrimethylammonium chloride.

Examples of the surfactant can include nonionic surfactants, cationic surfactants, anionic surfactants, and amphoteric surfactants. As the surfactant, these can be used singly or in combination of two or more.

Examples of the nonionic surfactant can include ethylene oxide propylene oxide alkyl ether, polyoxyethylene alkyl ether, polyoxyethylene-polyoxypropylene-block copolymer, alkyl polyoxyethylene-polyoxypropylene block copolymer ether, polyoxyethylene fatty acid ester, polyoxyethylene fatty acid monoester, polyoxyethylene fatty acid diester, polyoxyethylene sorbitan fatty acid ester, glycerol fatty acid ester ethylene oxide adduct, polyoxyethylene castor oil ether, hydrogenated castor oil ethylene oxide adduct, alkylamine ethylene oxide adduct, fatty acid amide ethylene oxide adduct, glycerol fatty acid ester, polyglycerol fatty acid ester, pentaerythritol fatty acid ester, sorbitol fatty acid ester, sorbitan fatty acid ester, sucrose fatty acid ester, polyhydric alcohol alkyl ether, fatty acid alkanolamide, acetylene glycol, acetylene alcohol, ethylene oxide adduct of acetylene glycol, and ethylene oxide adduct of acetylene alcohol.

Examples of the cationic surfactant can include alkyldimethylbenzylammonium chloride, alkyltrimethylammonium chloride, alkyl dimethyl ethyl ammonium ethyl sulfate, higher alkylamine acetate, higher alkylamine hydrochloride, adduct of ethylene oxide to a higher alkylamine, condensate of a higher fatty acid and polyalkylene polyamine, a salt of an ester of a higher fatty acid and alkanolamine, a salt of higher fatty acid amide, imidazoline cationic surfactant, and alkyl pyridinium salt.

Examples of the anionic surfactant can include higher alcohol sulfate salts, higher alkyl ether sulfate salts, α-olefin sulfate salts, alkylbenzene sulfonate salts, α-olefin sulfonate salts, reaction products of fatty acid halide and N-methyl taurine, dialkyl sulfosuccinate salts, higher alcohol phosphate ester salts, and phosphate ester salts of higher alcohol ethylene oxide adduct.

Examples of the amphoteric surfactant can include amino acid amphoteric surfactants such as alkali metal salts of alkylaminopropionic acid, betaine amphoteric surfactants such as alkyldimethylbetaine, and imidazoline amphoteric surfactants.

When the fiber diameter D of the glass fiber in the glass-fiber-reinforced resin molded product of the present embodiment is less than 5.0 μm, the glass fiber has difficulty in dispersing in the resin in forming the glass-fiber-reinforced resin molded product by molding, and as a result the glass-fiber-reinforced resin molded product has lower impact strength. When the fiber diameter D of the glass fiber is more than 17.0 μm, on the other hand, the total area of the interface between the glass fiber and the resin is smaller, and as a result the glass-fiber-reinforced resin molded product has lower impact strength.

In the glass-fiber-reinforced resin molded product of the present embodiment, the fiber diameter D of the glass fiber contained in the glass-fiber-reinforced resin molded product is preferably in the range of 5.5 to 13.0 μm, and more preferably in the range of 6.0 to 8.5 μm.

The fiber diameter D of the glass fiber means the diameter of each of glass filaments constituting the glass fiber and typically having a circular cross-sectional shape. The diameter of each of the glass filaments can be measured in accordance with JIS R 3420:2013. When each of the glass filaments has a non-circular cross-sectional shape (e.g., oval, long oval, rectangle, cocoon-like shape), the fiber diameter D means the diameter of a circle having the same area as that of the cross-sectional shape.

When the linear expansion coefficient α of the glass fiber in the glass-fiber-reinforced resin molded product of the present embodiment is less than 2.0 ppm/K, cracking is disadvantageously likely to progress at impacting, and when the linear expansion coefficient α of the glass fiber is more than 6.0 ppm/K, the strength of the glass fiber itself is disadvantageously low.

In the glass-fiber-reinforced resin molded product of the present embodiment, the linear expansion coefficient α of the glass fiber contained in the glass-fiber-reinforced resin molded product is preferably in the range of 2.8 to 4.4 ppm/K, and more preferably in the range of 3.1 to 4.0 ppm/K.

The linear expansion coefficient α of the glass fiber can be measured, for example, as follows.

First, the glass-fiber-reinforced resin molded product is heated, for example, in a muffle furnace at 300 to 650° C. for about 0.5 to 24 hours to decompose organic matter. Next, the remaining glass fiber is placed in a platinum crucible and melted with stirring while being held at a temperature of 1600° C. for 6 hours in an electric furnace to obtain homogeneous molten glass. Subsequently, the platinum crucible including the molten glass is taken out of the electric furnace to cool the molten glass. Next, the molten glass is tapped out of the platinum crucible, then heated at a strain removal temperature (660 to 750° C.) for 2 hours in order to remove the strain of the glass, and cooled to room temperature (20 to 25° C.) over 8 hours to thereby obtain a glass mass.

Next, the obtained glass mass is processed into a test piece of 4 mm×4 mm×20 mm using a cutting machine, for example, a diamond cutter and a grinder. Then, the obtained test piece is heated at a temperature increase rate of 10° C./min. Subsequently, the amount of elongation of the test piece is measured at a temperature in the range of 50 to 200° C. using a thermomechanical analyzer (manufactured by Hitachi High-Tech Science Corporation), and the linear expansion coefficient α of the glass fiber is determined by calculating the linear expansion coefficient from the amount of elongation.

When the tensile modulus E of the glass fiber in the glass-fiber-reinforced resin molded product of the present embodiment is smaller, the amount of deformation when external force is applied is excessively large, and when the tensile modulus E is larger, the glass-fiber-reinforced resin molded product tends to be brittle. Accordingly, when the tensile modulus E of the glass fiber in the glass-fiber-reinforced resin molded product of the present embodiment is less than 58 GPa, the glass-fiber-reinforced resin molded product has deteriorated handleability, and when the tensile modulus E of the glass fiber is more than 92 GPa, the glass-fiber-reinforced resin molded product is likely to have lower impact properties.

In the glass-fiber-reinforced resin molded product of the present embodiment, the tensile modulus E of the glass fiber contained in the glass-fiber-reinforced resin molded product is preferably in the range of 60 to 69 GPa, and more preferably in the range of 62 to 67 GPa.

The tensile modulus E of the glass fiber can be measured, for example, as follows.

First, the glass-fiber-reinforced resin molded product is heated, for example, in a muffle furnace at 300 to 650° C. for about 0.5 to 24 hours to decompose organic matter. Next, the remaining glass fiber is placed in a platinum crucible and melted with stirring while being held at a temperature of 1600° C. for 6 hours in an electric furnace to obtain homogeneous molten glass.

Next, the obtained molten glass is poured onto a carbon plate to produce a glass cullet, and then the obtained glass cullet is charged into a small tubular platinum bushing having a circular nozzle tip on the container bottom. Subsequently, the platinum bushing is heated to a specific temperature and the glass cullet is melted so that the viscosity of the charged glass cullet reaches 1000±150 poise, giving molten glass. The molten glass discharged from the nozzle tip of the platinum bushing is wound with a winding machine at specific speed so that a glass fiber diameter of 13±2 μm is provided, and cooled to solidify while being drawn, giving a glass filament having a perfect circle cross-sectional shape. One glass filament (monofilament) between the nozzle tip of the platinum bushing and the winding machine is collected as a sample for elastic modulus evaluation, for which the degradation due to contact and friction has been reduced as much as possible.

Next, on a mount including two holding parts and two supporting parts described later, the obtained monofilament is positioned along a line extending between the centers of the short sides in the long side direction, and adhered to prepare a monofilament test piece. Then, the diameter of the obtained monofilament is measured with a scanning electron microscope (manufactured by Hitachi, Ltd., product name: S-3400), and the cross-sectional area of the monofilament is calculated from the acquired diameter. Subsequently, the two holding parts of the mount are set on upper and lower chucks of a tensile tester (manufactured by A&D Company, Limited, product name: Tabletop Material Testing Instrument STB-1225S) with the chuck-to-chuck distance set to 50 mm.

Next, the two supporting parts of the mount are cut out to allow the holding parts to be connected only through the monofilament, and tensile test is then performed at a crosshead speed of 5 mm/min. Subsequently, the stresses corresponding to ε₁=0.0005 and ε₂=0.0025, each representing strain between two points, are defined as σ₁ and σ₂, respectively, and the tensile modulus is calculated by dividing the difference in stress (σ₂−σ₁) by the difference in strain (ε₂−ε₁). Monofilament test pieces that underwent the slip-off of the filament during measurement are excluded and the tensile modulus of the glass fiber is determined by calculating the mean of tensile moduli for n=15.

The mount has 25-mm short sides and 75-mm long sides, and includes an excluded part having 15-mm short sides and 50-mm long sides at the center of the inner area. The excluded part is present in such a manner that the short sides and long sides of the mount are respectively parallel with the short sides and long sides of the excluded part. The mount includes holding parts, which are to be set on chucks of a tensile tester, between the short sides of the excluded part and the short sides of the mount, and includes supporting parts to connect the two holding parts between the long sides of the excluded part and the long sides of the mount and support the holding parts.

In the glass-fiber-reinforced resin molded product of the present embodiment, when the glass fiber content C with respect to the total amount of the glass-fiber-reinforced resin molded product is more than 50.0% by mass, the resin tends to be brittle, and the glass-fiber-reinforced resin molded product has lower impact properties. When the glass fiber content C is less than 10.0% by mass, on the other hand, sufficient impact strength cannot be obtained.

In the glass-fiber-reinforced resin molded product of the present embodiment, the glass fiber content C with respect to the total amount of the glass-fiber-reinforced resin molded product is preferably in the range of 20.0 to 45.0% by mass, and more preferably in the range of 25.0 to 40.0% by mass.

The glass fiber content C of the glass-fiber-reinforced molded product of the present embodiment can be calculated in accordance with JIS K 7052:1999.

In the glass-fiber-reinforced resin molded product of the present embodiment, when the heat of crystallization Q of the glass-fiber-reinforced resin molded product with respect to the mass of the resin contained in the glass-fiber-reinforced resin molded product is less than 30.0 J/g or more than 60.0 J/g, the glass-fiber-reinforced resin molded product is likely to have lower impact properties.

In the glass-fiber-reinforced resin molded product of the present embodiment, the heat of crystallization Q of the glass-fiber-reinforced resin molded product with respect to the mass of the resin contained in the glass-fiber-reinforced resin molded product is preferably in the range of 35.0 to 50.0 J/g.

The heat of crystallization Q of the glass-fiber-reinforced resin molded product with respect to the mass of the resin contained in the glass-fiber-reinforced resin molded product can be determined, for example, as follows.

First, the glass-fiber-reinforced resin molded product is cut into pieces of about 10 mg to prepare a test piece, and the mass of the test piece is measured. Next, with a differential scanning calorimeter (e.g., manufactured by NETZCH, product name: DSC 3500 Sirius), the glass-fiber-reinforced resin molded product is heated to 370° C. at a heating rate of 40° C./min under purging with nitrogen, retained at 370° C. for 10 minutes, and then cooled to 200° C. at a cooling temperature of 40° C./min, giving a DSC curve. From the peak area in the obtained DSC curve, the heat of crystallization for the total mass of the test piece (Q₀) is determined.

Next, with the glass fiber content C measured with the method described above, the heat of crystallization Q of the glass-fiber-reinforced resin molded product with respect to the mass of the resin contained in the glass-fiber-reinforced resin molded product is determined from the following formula (A).

$$Q = {Q}_{0} / ( 100 - C ) \times 100 \qquad ( A )$$

The glass fiber contained in the glass-fiber-reinforced resin molded product of the present embodiment preferably has a number average fiber length, for example, in the range of 1 to 10000 μm. When the number average fiber length of the glass fiber is less than 1 μm, the glass-fiber-reinforced resin molded product may fail to have sufficient impact absorption properties and impact resistance. Providing the glass fiber with a number average fiber length of more than 10000 μm is difficult because the glass fiber, more specifically, the glass filaments constituting the glass fiber break in the manufacture process for the glass-fiber-reinforced resin molded product.

The number average fiber length of the glass fiber is preferably in the range of 50 to 3000 μm, more preferably in the range of 65 to 1800 μm, still more preferably in the range of 80 to 900 μm, particularly preferably in the range of 95 to 600 μm, and most preferably in the range of 100 to 300 μm.

For the glass fiber contained in the glass-reinforced resin molded product of the present embodiment, in contrast to typical glass fiber, which is formed of a plurality of glass filaments bundled together as described above, the bundle is loosened through the manufacture process for the glass-fiber-reinforced resin molded product, and the glass fiber is present in a state of glass filaments dispersed in the glass-fiber-reinforced resin molded product. Therefore, the number average fiber length of the glass fiber substantially means the number average fiber length of the glass filaments in the glass-fiber-reinforced resin molded product.

Measurement of the number average fiber length of the glass fiber contained in the glass-fiber-reinforced resin molded product of the present embodiment can be carried out as follows.

First, the glass-fiber-reinforced resin molded product is heated, for example, in a muffle furnace at 300 to 650° C. for about 0.5 to 24 hours to decompose organic matter. Next, the remaining glass filaments are transferred to a glass petri dish, and the glass filaments are dispersed using acetone on the surface of the petri dish. Subsequently, the fiber length of 500 or more glass filaments dispersed on the surface of the petri dish is measured using a stereoscopic microscope to calculate the number average fiber length.

The glass-fiber-reinforced resin molded product of the present embodiment, when the D, α, E, C, and Q satisfy the formula (1), has impact absorption properties at break and impact resistance at the unbroken phase in combination and in good balance with handleability.

Here, in the glass-fiber-reinforced resin molded product of the present embodiment, as the fiber diameter D of the glass fiber contained in the glass-fiber-reinforced resin molded product is smaller, the total area of the interface between the glass fiber and the resin is larger and hence the glass-fiber-reinforced resin molded product tends to have higher impact strength, but when the fiber diameter D of the glass fiber is excessively small, the glass fiber has difficulty in dispersing in the resin in forming the glass-fiber-reinforced resin molded product by molding, and as a result the glass-fiber-reinforced resin molded product has lower impact strength.

As the linear expansion coefficient α of the glass fiber is smaller, the glass backbone of the glass fiber is expected to be stronger, and hence the glass fiber tends to have enhanced strength and be more resistant to elongation. As the tensile modulus E of the glass fiber is larger, the glass fiber has enhanced strength and is more resistant to elongation, and hence as E/α² is larger, the glass fiber tends to have enhanced mechanical properties and higher flexural strength, and exhibit smaller flexural strain at flexural strength. On the other hand, as α is larger, the difference from the linear expansion coefficient of the resin is smaller and residual stress is less likely to be generated in the glass-fiber-reinforced resin molded product, and hence the glass-fiber-reinforced resin molded product tends to have enhanced impact absorption properties as E/α² is smaller.

In the glass-fiber-reinforced resin molded product of the present embodiment, as the glass fiber content C with respect to the total amount of the glass-fiber-reinforced resin molded product is higher, the amount of the glass fiber reinforcing the resin is larger, and hence the glass-fiber-reinforced resin molded product has enhanced impact strength.

In the glass-fiber-reinforced resin molded product of the present embodiment, when the heat of crystallization Q of the glass-fiber-reinforced resin molded product with respect to the mass of the resin contained in the glass-fiber-reinforced resin molded product is small, the resin tends to have large molecular weight, and the reinforcing fiber is likely to break during resin molding. When the heat of crystallization Q of the glass-fiber-reinforced resin molded product with respect to the mass of the resin contained in the glass-fiber-reinforced resin molded product is large, on the other hand, the resin tends to have a high crystallization rate and small molecular weight, and hence the resin tends to be brittle.

Thus, the formula (1) is inferred to represent the balance between the influence of the breaking and dispersiveness of the glass fiber in molding to the impact properties and the impact properties of the resin and the glass fiber themselves in the glass-fiber-reinforced resin molded product of the present embodiment.

The glass-fiber-reinforced resin molded product of the present embodiment, when the D, α, E, C, and Q are in the above ranges and satisfy the formula (1), has impact absorption properties at break and impact resistance at the unbroken phase in combination and in good balance with handleability. Having impact absorption properties at break and impact resistance at the unbroken phase in combination and in good balance with handleability means that the value of “modulus of toughness×notchless Charpy impact strength/flexural strain at flexural strength” is 350 or more.

The modulus of toughness can be determined from the following formula (B), and indicates resistance to rupture when the glass-fiber-reinforced resin molded product is subjected to external force, thus being an index of impact resistance at the unbroken phase.

(Modulus of toughness)=(flexural strength (MPa))/(2×flexural modulus (GPa)) (B)

The notchless Charpy impact strength is an index of impact absorption properties at break. The flexural strain at flexural strength is an index of the handleability of the glass-fiber-reinforced resin molded product, and tends to be larger when the glass-fiber-reinforced resin molded product has high impact resistance and high impact absorption properties, and impact resistance and impact absorption properties and handleability are in trade-off relationship. Accordingly, “modulus of toughness×notchless Charpy impact strength/flexural strain at flexural strength” is an index of having impact resistance and impact absorption properties in combination and in good balance with handleability.

Here, the notchless Charpy impact strength is measured by performing notchless Charpy impact test in accordance with JIS K 7111-1:2012 for a type-A dumbbell test piece (thickness: 4 mm) in accordance with JIS K 7164:2005 with a digital impact tester (manufactured by Toyo Seiki Seisaku-sho, Ltd., model DG-UB) under a test temperature of 23° C.

With a universal testing machine (manufactured by Shimadzu Corporation, product name: AUTOGRAPH AG-Xplus50kN), the flexural strength, flexural modulus, and flexural strain at flexural strength of the glass-fiber-reinforced resin molded product are measured for a test piece for flexural evaluation (length: 80 mm, width: 10 mm, thickness: 4 mm) obtained through processing by cutting both ends of the dumbbell test piece in accordance with JIS K 7171:2016 under a test temperature of 23° C.

In the glass-fiber-reinforced resin molded product of the present embodiment, the D, α, E, C, and Q preferably satisfy the following formula (1a), more preferably satisfy the following formula (2), and still more preferably satisfy the following formula (3).

$$16.87 \leq Q \times E / ( {D}^{1 / 3} \times {C}^{1 / 2} \times {α}^{2} ) \leq 24.9 \qquad ( 1 a )$$

$$18.74 \leq Q \times E / ( {D}^{1 / 3} \times {C}^{1 / 2} \times {α}^{2} ) \leq 21 \text{.74} \qquad ( 2 )$$

$$20.24 \leq Q \times E / ( {D}^{1 / 3} \times {C}^{1 / 2} \times {α}^{2} ) \leq 21 \text{.54} \qquad ( 3 )$$

The glass-fiber-reinforced resin molded product of the present embodiment, when the D, α, E, C, and Q are in the above ranges and satisfy the formula (2), has impact absorption properties at break and impact resistance at the unbroken phase in combination and in better balance with handleability. Having impact absorption properties at break and impact resistance at the unbroken phase in combination and in better balance with handleability means that the value of “modulus of toughness×notchless Charpy impact strength/flexural strain at flexural strength” is 370 or more.

The glass-fiber-reinforced resin molded product of the present embodiment, when the D, α, E, C, and Q are in the above ranges and satisfy the formula (3), has impact absorption properties at break and impact resistance at the unbroken phase in combination and in much better balance with handleability. Having impact absorption properties at break and impact resistance at the unbroken phase in combination and in much better balance with handleability means that the value of “modulus of toughness×notchless Charpy impact strength/flexural strain at flexural strength” is 400 or more.

Examples of applications of the glass-fiber-reinforced resin molded product of the present embodiment can include: housings and parts, such as motherboards, frames, speakers, and antennas, of portable electronic devices such as smartphones, tablet computers, and laptop computers; switches; gears; connectors; motor parts; parts of semiconductor/liquid crystal production apparatuses; electronic and electric parts such as insulating films and cable sheaths; automotive parts such as bearings, seal rings, gears, transmission parts, thrust washers, piston parts, and spindle nuts; aircraft parts such as bracket fasteners, compartment retainers, vent grills, and structural members; artificial satellite parts; and 3D printer materials.

Examples and Comparative Examples of the present invention will be shown.

### EXAMPLES

### Example 1

In the present example, first, glass fiber (manufactured by Nitto Boseki Co., Ltd., NE glass chopped strands) in an amount of 30.0% by mass with respect to the total amount (glass fiber content C) and polyether ether ketone (manufactured by Daicel-Evonik Ltd., product name: VESTAKEEP L4000G (represented as “PEEK L4000G” in Tables 1 and 2)) in an amount of 70.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

The glass fiber had a linear expansion coefficient α of 3.3 ppm/K, a tensile modulus E of 64 GPa, and a fiber diameter D of 6.5 μm.

Then, the resin pellets obtained in the present example were injection-molded with an injection molding machine (manufactured by Nissei Plastic Industrial Co. Ltd., product name: NEX80-9E) at a mold temperature of 200° C. and an injection temperature of 410° C. to prepare a multipurpose test piece type A1 (thickness: 4 mm) in accordance with JIS K 7139:2009 as a glass-fiber-reinforced resin molded product of the present example. The number average fiber length of the glass fiber contained in the glass-fiber-reinforced resin molded product was 113 μm as determined with the method described above.

Next, the method described above was applied to the multipurpose test piece type A1 to determine the heat of crystallization Q of the glass-fiber-reinforced resin molded product with respect to the mass of the resin contained in the glass-fiber-reinforced resin molded product. Then, the value of Q×E/(D^{1/3}×C^{1/2}α²) was calculated from the D, α, E, C, and Q.

The methods described above were applied to the multipurpose test piece type A1 to determine the flexural strain at flexural strength, flexural strength, flexural modulus, modulus of toughness, and notchless Charpy impact strength of the glass-fiber-reinforced resin molded product of the present example, and the value of modulus of toughness×notchless Charpy impact strength/flexural strain at flexural strength was calculated. Table 1 shows the results.

### Example 2

In the present example, first, a multipurpose test piece type A1 (thickness: 4 mm) in accordance with JIS K 7139:2009 was prepared as a glass-fiber-reinforced resin molded product of the present example completely in the same manner as in Example 1, except that glass fiber having a fiber diameter D of 11 μm (manufactured by Nitto Boseki Co., Ltd., NE glass chopped strands) in an amount of 40.0% by mass with respect to the total amount (glass fiber content C) and polyether ether ketone (manufactured by Daicel-Evonik Ltd., product name: VESTAKEEP 2000G (represented as “PEEK 2000G” in Tables 1 and 2)) in an amount of 60.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present example was used. Table 1 shows the results.

### Example 3

In the present example, first, a multipurpose test piece type A1 (thickness: 4 mm) in accordance with JIS K 7139:2009 was prepared as a glass-fiber-reinforced resin molded product of the present example completely in the same manner as in Example 1, except that glass fiber having a fiber diameter D of 11 μm (manufactured by Nitto Boseki Co., Ltd., NE glass chopped strands) in an amount of 30.0% by mass with respect to the total amount (glass fiber content C) and polyether ether ketone (manufactured by Daicel-Evonik Ltd., product name: VESTAKEEP 2000G (represented as “PEEK 2000G” in Tables 1 and 2)) in an amount of 70.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present example was used. Table 1 shows the results.

### Example 4

In the present example, first, a multipurpose test piece type A1 (thickness: 4 mm) in accordance with JIS K 7139:2009 was prepared as a glass-fiber-reinforced resin molded product of the present example completely in the same manner as in Example 1, except that glass fiber having a fiber diameter D of 11 μm (manufactured by Nitto Boseki Co., Ltd., NE glass chopped strands) in an amount of 20.0% by mass with respect to the total amount (glass fiber content C) and polyether ether ketone (manufactured by Daicel-Evonik Ltd., product name: VESTAKEEP 2000G (represented as “PEEK 2000G” in Tables 1 and 2)) in an amount of 80.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present example was used. Table 1 shows the results.

### Comparative Example 1

In the present comparative example, a multipurpose test piece type A1 (thickness: 4 mm) in accordance with JIS K 7139:2009 was prepared as a glass-fiber-reinforced resin molded product of the present comparative example completely in the same manner as in Example 2, except that glass fiber having a linear expansion coefficient α of 5.5 ppm/K and a tensile modulus E of 75 GPa (manufactured by Nitto Boseki Co., Ltd., E glass chopped strands) was used.

Next, the value of Q×E/(D^{1/3}×C^{1/2}×α²) and the value of modulus of toughness×notchless Charpy impact strength/flexural strain at flexural strength were calculated completely in the same manner as in Example 2, except that the multipurpose test piece type A1 obtained in the present comparative example was used. Table 2 shows the results.

### Comparative Example 2

In the present comparative example, a multipurpose test piece type A1 (thickness: 4 mm) in accordance with JIS K 7139:2009 was prepared as a glass-fiber-reinforced resin molded product of the present comparative example completely in the same manner as in Example 2, except that glass fiber having a linear expansion coefficient α of 2.8 ppm/K, a tensile modulus E of 86 GPa, and a fiber diameter D of 9 μm was used to the total amount of the glass fiber.

Next, the value of Q×E/(D^{1/3}×C^{1/2}×α²) and the value of modulus of toughness×notchless Charpy impact strength/flexural strain at flexural strength were calculated completely in the same manner as in Example 2, except that the multipurpose test piece type A1 obtained in the present comparative example was used. Table 2 shows the results.

### Comparative Example 3

In the present comparative example, a multipurpose test piece type A1 (thickness: 4 mm) in accordance with JIS K 7139:2009 was prepared as a glass-fiber-reinforced resin molded product of the present comparative example completely in the same manner as in Example 1, except that glass fiber having such a composition that the linear expansion coefficient α was 5.5 ppm/K and the tensile modulus E was 75 GPa and having a fiber diameter D of 11 μm (manufactured by Nitto Boseki Co., Ltd., E glass chopped strands) was used.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present comparative example was used. Table 2 shows the results.

### Comparative Example 4

In the present comparative example, a multipurpose test piece type A1 (thickness: 4 mm) in accordance with JIS K 7139:2009 was prepared as a glass-fiber-reinforced resin molded product of the present comparative example completely in the same manner as in Example 1, except that glass fiber having a linear expansion coefficient α of 5.5 ppm/K and a tensile modulus E of 75 GPa (manufactured by Nitto Boseki Co., Ltd., E glass chopped strands) was used.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present comparative example was used. Table 2 shows the results.

### Comparative Example 5

In the present comparative example, a multipurpose test piece type A1 (thickness: 4 mm) in accordance with JIS K 7139:2009 was prepared as a glass-fiber-reinforced resin molded product of the present comparative example completely in the same manner as in Example 1, except that glass fiber having a linear expansion coefficient α of 2.8 ppm/K, a tensile modulus E of 86 GPa, and a fiber diameter D of 11 μm was used.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present comparative example was used. Table 2 shows the results.

### Comparative Example 6

In the present comparative example, first, glass fiber (manufactured by Nitto Boseki Co., Ltd., NE glass chopped strands) in an amount of 30.0% by mass with respect to the total amount (glass fiber content C) and polyphenylene sulfide (manufactured by KUREHA CORPORATION, product name: Fortron KPS W203A (represented as “PPS” in Table 3)) in an amount of 70.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

The glass fiber had a linear expansion coefficient α of 3.3 ppm/K, a tensile modulus E of 64 GPa, and a fiber diameter D of 6.5 μm.

Then, a multipurpose test piece type A1 (thickness: 4 mm) in accordance with JIS K 7139:2009 was prepared as a glass-fiber-reinforced resin molded product of the present comparative example completely in the same manner as in Example 1, except that the resin pellets obtained in the present comparative example were used.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present comparative example was used. Table 3 shows the results.

### Comparative Example 7

In the present comparative example, a multipurpose test piece type A1 (thickness: 4 mm) in accordance with JIS K 7139:2009 was prepared as a glass-fiber-reinforced resin molded product of the present comparative example completely in the same manner as in Comparative Example 6, except that glass fiber having a linear expansion coefficient α of 5.5 ppm/K and a tensile modulus E of 75 GPa (manufactured by Nitto Boseki Co., Ltd., E glass chopped strands) was used.

Next, the value of Q×E/(D^{1/3}×C^{1/2}×α²) and the value of modulus of toughness×notchless Charpy impact strength/flexural strain at flexural strength were calculated completely in the same manner as in Comparative Example 6, except that the multipurpose test piece type A1 obtained in the present comparative example was used. Table 3 shows the results.

### Comparative Example 8

In the present comparative example, first, glass fiber (manufactured by Nitto Boseki Co., Ltd., NE glass chopped strands) in an amount of 30.0% by mass with respect to the total amount (glass fiber content C) and polybutylene terephthalate (manufactured by Polyplastics Co., Ltd., product name: DURANEX 2000 (represented as “PBT” in Table 3)) in an amount of 70.0% by mass with respect to the total amount were kneaded with a twin-screw kneader (manufactured by SHIBAURA MACHINE CO., LTD., product name: TEM-26SS) at a kneading temperature of 390° C. and a screw rotational frequency of 100 rpm to give resin pellets.

The glass fiber had a linear expansion coefficient α of 3.3 ppm/K, a tensile modulus E of 64 GPa, and a fiber diameter D of 11 μm.

Then, a multipurpose test piece type A1 (thickness: 4 mm) in accordance with JIS K 7139:2009 was prepared as a glass-fiber-reinforced resin molded product of the present comparative example completely in the same manner as in Example 1, except that the resin pellets obtained in the present comparative example were used.

Next, the value of Q×E/(D^{1/3}×C^{1/2}×α²) and the value of modulus of toughness×notchless Charpy impact strength/flexural strain at flexural strength were calculated completely in the same manner as in Example 1, except that the multipurpose test piece type A1 obtained in the present comparative example was used. Table 3 shows the results.

### Comparative Example 9

In the present comparative example, a multipurpose test piece type A1 (thickness: 4 mm) in accordance with JIS K 7139:2009 was prepared as a glass-fiber-reinforced resin molded product of the present comparative example completely in the same manner as in Comparative Example 8, except that glass fiber having a linear expansion coefficient α of 5.5 ppm/K and a tensile modulus E of 75 GPa (manufactured by Nitto Boseki Co., Ltd., E glass chopped strands) was used.

Next, the value of Q×E/(D^{1/3}×C^{1/2}×α²) and the value of modulus of toughness×notchless Charpy impact strength/flexural strain at flexural strength were calculated completely in the same manner as in Comparative Example 8, except that the multipurpose test piece type A1 obtained in the present comparative example was used. Table 3 shows the results.

TABLE 1

| | Example | Example | Example | Example |
|---|---|---|---|---|
| | 1 | 2 | 3 | 4 |
| Resin | PEEK | PEEK | PEEK | PEEK |
| | L4000G | 2000G | 2000G | 2000G |
| Heat of crystallization Q with respect to mass of | 36.7 | 46.4 | 46.4 | 46.4 |
| resin (J/g) | | | | |
| Glass composition | A | A | A | A |
| Fiber diameter D (μm) | 6.5 | 11 | 11 | 11 |
| Glass fiber content C (% by mass) | 30 | 40 | 30 | 20 |
| Q × E/(D^{1/3} × C^{1/3} × α²) | 21.10 | 19.39 | 22.39 | 27.42 |
| Flexural strain at flexural strength (%) | 3.77 | 2.43 | 3.06 | 3.61 |
| Flexural strength (MPa) | 270 | 295 | 262 | 240 |
| Flexural modulus (GPa) | 9.0 | 12.0 | 9.0 | 7.0 |
| Modulus of toughness | 15.0 | 12.3 | 14.6 | 17.1 |
| Notchless Charpy impact strength (kJ/m²) | 110 | 75 | 75 | 74 |
| Modulus of toughness × Notchless Charpy impact | 438 | 380 | 358 | 351 |
| strength/flexural strain at flexural strength | | | | |

TABLE 2

| | Comparative | Comparative | Comparative | Comparative | Comparative |
|---|---|---|---|---|---|
| | Example 1 | Example 2 | Example 3 | Example 4 | Example 5 |
| Resin | PEEK | PEEK | PEEK | PEEK | PEEK |
| | 2000G | 2000G | L4000G | L4000G | L4000G |
| Heat of crystallization Q with | 46.4 | 46.4 | 36.7 | 36.7 | 36.7 |
| respect to mass of resin (J/g) | | | | | |
| Glass composition | B | C | B | B | C |
| Fiber diameter D (μm) | 11 | 9 | 11 | 6.5 | 11 |
| Glass fiber content C (% by | 40 | 40 | 30 | 30 | 30 |
| mass) | | | | | |
| Q × E/(D^{1/3} × C^{1/3} × α²) | 8.18 | 38.69 | 7.47 | 8.90 | 33.05 |
| Flexural strain at flexural | 2.28 | 2.49 | 3.00 | 3.29 | 2.99 |
| strength (%) | | | | | |
| Flexural strength (MPa) | 270 | 330 | 245 | 265 | 270 |
| Flexural modulus (GPa) | 13.0 | 15.0 | 10.0 | 10.0 | 11.0 |
| Modulus of toughness | 10.4 | 11.0 | 12.3 | 13.2 | 12.3 |
| Notchless Charpy impact | 57 | 72 | 67 | 85 | 75 |
| strength (kJ/m²) | | | | | |
| Modulus of | 260 | 318 | 275 | 341 | 309 |
| toughness × Notchless Charpy | | | | | |
| impact strength/flexural | | | | | |
| strain at flexural strength | | | | | |

TABLE 3

| | Comparative | Comparative | Comparative | Comparative |
|---|---|---|---|---|
| | Example 6 | Example 7 | Example 8 | Example 9 |
| Resin | PPS | PPS | PBT | PBT |
| Heat of crystallization Q with | 52.2 | 52.2 | 58 | 58 |
| respect to mass of resin (J/g) | | | | |
| Glass composition | A | B | A | B |
| Fiber diameter D (μm) | 6.5 | 6.5 | 11 | 11 |
| Glass fiber content C (% by mass) | 30 | 30 | 30 | 30 |
| Q × E/(D^{1/3} × C^{1/3} × α²) | 30.01 | 12.66 | 27.98 | 11.81 |
| Flexural strain at flexural strength | 2.16 | 2.11 | 3.00 | 2.88 |
| (%) | | | | |
| Flexural strength (MPa) | 225 | 240 | 225 | 232 |
| Flexural modulus (GPa) | 10.4 | 11.5 | 9.0 | 10.0 |
| Modulus of toughness | 10.8 | 10.4 | 12.5 | 11.6 |
| Notchless Charpy impact | 43 | 37 | 70 | 66 |
| strength (kJ/m²) | | | | |
| Modulus of toughness × Notchless | 215 | 182 | 292 | 266 |
| Charpy impact strength/flexural | | | | |
| strain at flexural strength | | | | |

As can be seen from Tables 1 to 3, each of the glass-fiber-reinforced resin molded products of Examples 1 to 4 was such that the glass fiber had a fiber diameter D in the range of 5.0 to 17.0 μm, the glass fiber had a linear expansion coefficient α in the range of 2.0 to 6.0 ppm/K, the glass fiber had a tensile modulus E in the range of 58 to 92 GPa, the glass-fiber-reinforced resin molded product had a glass fiber content C in the range of 10.0 to 50.0% by mass with respect to the total amount of the glass-fiber-reinforced resin molded product, the heat of crystallization Q of the glass-fiber-reinforced resin molded product with respect to the mass of the resin contained in the glass-fiber-reinforced resin molded product was in the range of 30.0 to 60.0 J/g, and the D, α, E, C, and Q satisfied the formula (1).

It can be seen that as a result each of the glass-fiber-reinforced resin molded products of Examples 1 to 4 exhibited a value of modulus of toughness×notchless Charpy impact strength/flexural strain at flexural strength of 350 or more, as an index of having impact absorption properties at break and impact resistance at the unbroken phase in combination and in good balance with handleability, thus having impact absorption properties at break and impact resistance at the unbroken phase in combination and in good balance with handleability over the glass-fiber-reinforced resin molded products of Comparative Examples 1 to 9.

The value of modulus of toughness×notchless Charpy impact strength/flexural strain at flexural strength for the glass-fiber-reinforced resin molded product of Example 1 was 128% of that for the glass-fiber-reinforced resin molded product of Comparative Example 4, which had completely the same configuration except that the glass composition of the glass fiber was equivalent to that of E glass, and thus it is obvious that the glass-fiber-reinforced resin molded product of Example 1 had impact absorption properties at break and impact resistance at the unbroken phase in combination and in good balance with handleability over the glass-fiber-reinforced resin molded product of Comparative Example 4.

The value of modulus of toughness×notchless Charpy impact strength/flexural strain at flexural strength for the glass-fiber-reinforced resin molded product of Example 2 was 146% of that for the glass-fiber-reinforced resin molded product of Comparative Example 1, which had completely the same configuration except that the glass composition of the glass fiber was equivalent to that of E glass, and thus it is obvious that the glass-fiber-reinforced resin molded product of Example 2 had impact absorption properties at break and impact resistance at the unbroken phase in combination and in good balance with handleability over the glass-fiber-reinforced resin molded product of Comparative Example 1.

On the other hand, it can be seen that the value of modulus of toughness×notchless Charpy impact strength/flexural strain at flexural strength for the glass-fiber-reinforced resin molded product of Comparative Example 6 was 118% of that for the glass-fiber-reinforced resin molded product of Comparative Example 7, which had completely the same configuration except that the glass composition of the glass fiber was equivalent to that of E glass. It can be seen that the value of modulus of toughness×notchless Charpy impact strength/flexural strain at flexural strength for the glass-fiber-reinforced resin molded product of Comparative Example 8 was 110% of that for the glass-fiber-reinforced resin molded product of Comparative Example 9, which had completely the same configuration except that the glass composition of the glass fiber was equivalent to that of E glass.

1. A glass-fiber-reinforced resin molded product, wherein
glass fiber comprised in the glass-fiber-reinforced resin molded product has a fiber diameter D in a range of 5.0 to 17.0 μm, the glass fiber has a linear expansion coefficient α in a range of 2.0 to 6.0 ppm/K, the glass fiber has a tensile modulus E in a range of 58 to 92 GPa,
the glass-fiber-reinforced resin molded product has a glass fiber content C in a range of 10.0 to 50.0% by mass with respect to the total amount of the glass-fiber-reinforced resin molded product,
heat of crystallization Q of the glass-fiber-reinforced resin molded product is in a range of 30.0 to 60.0 J/g with respect to mass of resin comprised in the glass-fiber-reinforced resin molded product, and
the D, α, E, C, and Q satisfy following formula (1):
$$16.02 \leq Q \times E / ( {D}^{1 / 3} \times {C}^{1 / 2} \times {α}^{2} ) \leq 27 \text{.70} \qquad ( 1 )$$

2. The glass-fiber-reinforced resin molded product according to claim 1, wherein the D, α, E, C, and Q satisfy following formula (2):
$$18.74 \leq Q \times E / ( {D}^{1 / 3} \times {C}^{1 / 2} \times {α}^{2} ) \leq 21 \text{.74} \qquad ( 2 )$$

3. The glass-fiber-reinforced resin molded product according to claim 1, wherein the D, α, E, C, and Q satisfy following formula (3):
$$20.24 \leq Q \times E / ( {D}^{1 / 3} \times {C}^{1 / 2} \times {α}^{2} ) \leq 21 \text{.54} \qquad ( 3 )$$

4. The glass-fiber-reinforced resin molded product according to claim 1, wherein the resin comprised in the glass-fiber-reinforced resin molded product is polyaryl ether ketone.

5. The glass-fiber-reinforced resin molded product according to claim 2, wherein the resin comprised in the glass-fiber-reinforced resin molded product is polyaryl ether ketone.

6. The glass-fiber-reinforced resin molded product according to claim 3, wherein the resin comprised in the glass-fiber-reinforced resin molded product is polyaryl ether ketone.
